(19) United States
(12) Patent Application Publication
(10) Pub. No.: US 2014/0177897 A1
(43) Pub. Date: Jun. 26, 2014

(54) HEADPHONE SPEAKER SANITARY COVER FOR PREVENTING CONTAMINATION AND INFECTIOUS DISEASES DUE TO SEBUM AND SWEAT

(71) Applicant: Chang-weon Baik, Seoul (KR)

(72) Inventor: Chang-weon Baik, Seoul (KR)

(21) Appl. No.: 14/124,332

(22) PCT Filed: Oct. 10, 2012
(86) PCT No.: PCT/KR2012/008214

§ 371 Date: Dec. 6, 2013

(30) Foreign Application Priority Data
Oct. 12, 2011 (KR) 20-2011-0009068

(51) Int. Cl. H04R 1/12

(52) U.S. Cl. CPC H04R 1/12
USPC 381/370

(57) ABSTRACT

Disclosed are a speaker sanitary cover for preventing a speaker cover from being contaminated due to sebum and sweat naturally produced from skin of the body and preventing various bacterial or vial infectious diseases from being transmitted from a contaminated cover when headphones according to a related art are worn. A representative configuration of the present invention includes a functional sanitary cover (001) in which a paper towel cover (005) processed to easily absorb sebum and sweat improve air permeability, is coupled to a flexible band (003) having a predetermined shape and detachably disposed on a conventional headphone speaker cover body cover.

### TECHNICAL FIELD

This invention is in regards to manufacturing methods of sanitary headphone speaker cover which includes sanitary canopy, outer canopy and outer cover that prevent the speaker cover from being contaminated through sweat, sebum and other secretions from the human skin as well as preventing contagious diseases that may result from everyday use of the contaminated speaker cover or when the headphone is being used in public places.

### BACKGROUND ART

In most cases, headphone speakers have sponge covers with certain shapes or detachable covers coated with synthetic vinyl resin over them for dust resistance, product protection, making the product look good or to enhance the wearability. This is designed to block other noises from the surrounding area for the consumer to experience better sound quality as speaker cover naturally adheres to the skin when it covers the ears.

The following complication does not stand out when the headphone hasn't been in use for a long time but through prolonged usage, the complication where speaker cover is stained through the natural secretions from human skin such as sweat, sebum and other discharges become increasingly more obvious. These stains are not easily removed even when the consumer attempts to clean up the cover. Moreover, this problem gets worse when the speaker covers are brighter in color.

In order to resolve this problem, headphone manufacturers usually cover the stain up by attaching dark covers as much as possible but this cannot eliminate the unpleasant sensation that results from the contaminated speaker cover. Furthermore, this can only serve as a temporary measure and cannot be considered as proper solution to the problem due to sanitary reasons.

There are several problems caused by using the headphone with synthetic vinyl resin cover such as slippery headphone cover caused by air blockage and stickiness among others, especially during the heat wave season in summer. This problem gets worse when person with oily type skin uses this kind of headphone as the consumer would usually be in great discomfort and gives up on using the headphone all together. This is the reason why consumers make the switch to earphones even though they want to listen to the music or watch movies with more vibrant sounds through the headphone. The headphone that was previously used is most likely to be abandoned for few months during the summer and this could cause various types of fungi to break out in the outer surface because of sebum and sweat that had accumulated in time.

There may be abrasions on the surface when consumer cleans it for sanitary reasons for prolonged period of time. As time passes, surface of the cover naturally deteriorates as acidic secretions such as sweat and sebum produce synergistic effects which cause even more serious problems.

As the surface of the headphone cover gradually peels off and small holes begin to appear on the surface, secretions from human skin infiltrates the perforated sponge deeply. Due to this occurrence, the sponge and the cover surface is now a breeding ground for various bacteria and fungi which are harmful to human health. This is not good for personal hygiene and more likely to cause severe negative effects on people with atopic allergies.

For these reasons, contaminated covers should be changed to new ones when they are soiled but it is difficult for consumers to change the covers of the headphone speakers with ease as is the case with most of the headphones that are out in the market.

Moreover, cover that fits the headphone perfectly should be purchased in order to maintain its original shape as the sizes and shapes of the headphone covers greatly differ by model types and manufacturing companies. However, it is quite inconvenient for consumers to purchase the cover that had been specifically designed for the headphone as this process involves placing inquiries to the manufacturing companies' service centers, placing orders in person and waiting for weeks or even months at a time.

It should also be noted that several headphone covers should be purchased in order for consumers to change them in a regular basis. However, unit price of the headphone covers tend to be overly expensive as it is directly related to price of the headphones. Current situation forces the consumers to bear with various inconveniences all because of a headphone cover.

It is most likely that consumers will experience difficulties that have been mentioned above except for cases where size of the headphone covers are small or thin just like the earphone where it can be placed directly inside the ears and when the size of the headphone is similar to that of an earphone or if it is a clip-on headphone as the covers can be easily replaced also as it is easier to purchase similar covers that are cheaper than the original. However, problems that had been mentioned above are all present in cases where the headphone covers are in a form of big, thick sponges which covers the earflaps and has direct contact with the skin.

There are several instances where headphone itself has to be thrown away even when it is still functioning merely because of the complications that arise from the headphone cover. It is safe to assume that this causes significant financial loss for the consumers.

It could be quite irksome and unsanitary to use the headphones that are in public places such as audio visual rooms, booths in broadcasting stations, music booths in the record store among others as several people had been using them as well. But people have no choice but to make use of them as there are no alternatives provided. Using the headphones that so many people have used in time where there are countless types of contagious bacterial diseases are less than ideal for public health and sanitation.

### DISCLOSURE

### Technical Problem

In conclusion, headphone speaker cover is made to be in direct contact with the human skin and thus faces various challenges that had been mentioned above.

Therefore, in order to prevent the headphone speaker cover from being contaminated through various secretions from the human skin and in efforts to stave off various contagious diseases and also to make it easier to change the covers that are more affordable where they can be purchased in bulks, there is a need for the second cover that can be placed over the original headphone cover.

### Technical Solution

Therefore, this invention seeks to place the second cover over the original headphone cover in much more convenient way for certain types of headphones which includes clip-on headphones as well.

### Advantageous Effects

The original headphone cover (001) will be in its original place and the sanitary cover, (002) which is created according to the specification of this invention, can be placed over it. As this is the case, anyone can easily change the headphone cover quite conveniently.

Although another cover is placed over the headphone speaker, it does not affect the quality of the sound from the headphone speaker as the cover is perforated, allowing the air to easily pass through. This enables the sound to go through without any hindrances.

Moreover, the consumers can use the headphone without any discomfort as second cover is much thinner than the original headphone cover.

It is very sanitary as the second cover blocks the sweat and sebum from the skin from the original cover thus preventing the original cover surface from contamination and stains.

Disposable covers would be provided for public use for sanitary reasons as it prevents various germs and virus related contagious diseases.

As sanitary covers can be massively produced with significantly lower production cost, it poses less of a burden for customers as well. It is also economical since the covers can be reused several times after washing.

Through the use of sanitary covers, headphones can now be used to the fullest extent time wise and can always be kept in brand new state.

The functional sanitary cover can absorb sweat and sebum much better than the sponge as it has better air permeability because the surface that touches skin is made of paper towel like material which always provides fresh and dry sensation. It is very effective especially in hot summer season as it helps eliminate unpleasant sensation such as stickiness.

The functional sanitary cover has an elastic band with Velcro for paper or the fibers cover to be easily detachable thus providing more convenience and economical value.

It does not affect the general features of the headphone in any way. Rather, it adds improvement to the features as it breaks away from the dull monochromatic color of the headphone cover to provide various colors and colorful patterns. It can be customized according to individual customer's tastes thus proving to be more effective.

In addition, headphone manufacturing companies will able to increase their profit margin when they also make sanitary covers that can go along with the headphone speaker covers.

Consumers will be able to buy the sanitary covers in bulks at a cheap price thus creating a win-win situation for both manufacturers and consumers.

### DESCRIPTION OF DRAWINGS

FIG. 1(A) is the elastic band's edge (003) that is detachable from the speaker cover (001) with the elastic Velcro band attached in several places (006). Cover made of synthetic and paper towel fiber (007) with detachable Velcro parts (008) is attached to the functional sanitary cover (002) is depicted in this diagram. The partial cross sectional diagram (Aa) depicts elastic Velcro band with paper or fiber over (007) attached to it. Front view (B) and the right sided diagram (Ba) of the elastic Velcro band mentioned above are also shown.

FIG. 2 shows the sanitary cover (002) with different sizes and shapes according to the headphone speaker.

FIG. 2(A) is the diagram for functional sanitary cover made of elastic band (003) detachable from the original speaker cover (001) where paper or paper towel cover (005) is combined in twofold consisting of inner and outer skin with sebum absorbent paper (009) in the middle. Elastic band and the paper towel cover are separated in partial cross sectional diagram (Aa) and the partial diagram when it is put together. (Ab)

FIG. 2(B) is the slanted diagram for another sanitary cover (002) with round and rimpled shape that resembles microphone cover made from paper towel or other synthetic fiber along with elastic band (synthetic fiber or elastic band).

FIG. 2(C) is a slanted diagram for another sanitary cover (002) composed of square shaped sponge or paper towel.

FIG. 2(D) is the slanted diagram for functional sanitary cover of an elastic band (003) and the paper towel cover (005) put together and also its partial cross sectional diagram (Da) and the deal drawing (Db).

First, in order to prevent the original headphone speaker from being contaminated or infected with contagious diseases, the second cover that had been mentioned above will be defined as sanitary cover. It is also named as overlay cover in the same way there is an outer door.

According to the current invention, sanitary cover is made up of processed materials with good air permeability so that sound can be transferred well. Materials such as sponge, pulp, synthetic fiber, and paper or nylon synthetic fiber are used. The sponge and the pulp that had been used from synthetic fiber or paper as well as nylon or synthetic fiber that are usually used for speaker cover are used. The paper that can absorb sweat and sebum which is not easily torn when it is wet made from chemical synthesis is used.

This sanitary cover made according to the invention can be formed by different types according to the materials that have been mentioned above.

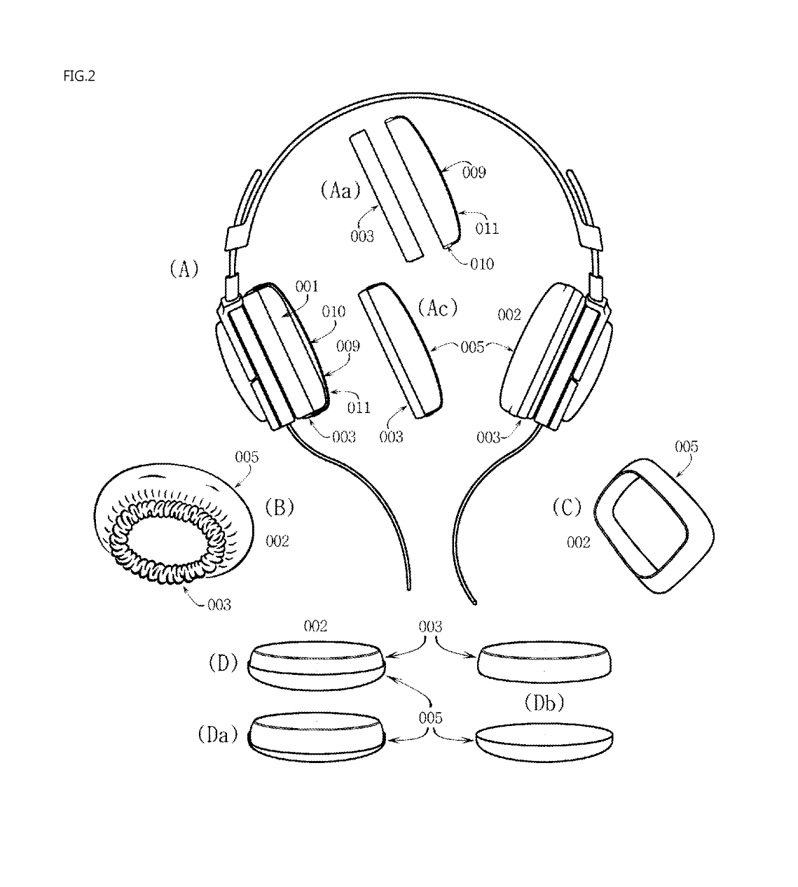

First, the manufacturing method of the sanitary cover which is made from the same material as the original sponge headphone cover is as follows. Mold is created according to the shape and size of the cover (001) with the sponge material and it will be shaped much thinner than the original cover as seen in FIG. 2(C).

Secondly, the sanitary cover made from fiber or paper towel will be cut out to be certain shape and size according to the cover. As seen in FIG. 2(B), elastic band (003, made of elastic synthetic fiber or rubber band) is placed at the edge just like the microphone cover. The size will be classified as big, medium and small according to the cover. Through this, it will be easier to place the second cover to the original covers that are shaped like a circle, oval, and even squares. There are various colors and patterns as well so that the consumers can select what they want according to their personal preference.

Thirdly, paper towel cover (005) is formed in another way by placing paper materials in a mold which is based on the original headphone cover as seen on the FIG. 2 (D, Da, Db, C).

Moreover, paper type sanitary cover can be made with one or two to four plies. Also, the thickness of the paper towel cover (005) can be made thinner by shaping them separately as inner skin (010) and outer skin (011) as seen on the FIG. 2 (A, Aa, Ab). Also, the sebum absorption paper (009) can be placed in the middle to form a functional sanitary cover.

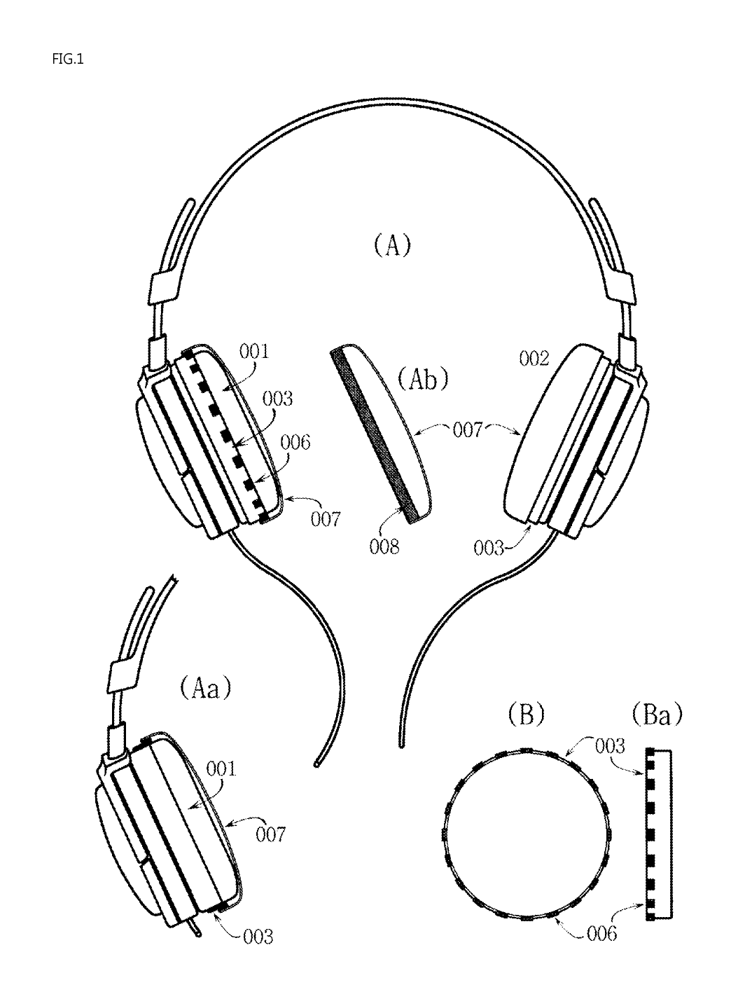

Moreover, it should also be noted that functional sanitary cover where fiber (paper, paper towel or synthetic fiber) cover (007) is made detachable by placing small Velcro (006) in several places to form a detachable Velcro area (008) can be created as seen in FIG. 1 (A, Aa, Ab).

Also, when the sanitary cover is made with the material that doesn't have good permeability such as polyvinyl coating, there could be certain number of small holes placed in the middle for better sound.

Method of manufacturing can either be as handcraft by making use certain tools or it can be massively produced by automatic manufacturing system.

When the consumer uses the sanitary cover, he or she can place the cover that fits the headphone speaker to be changed whenever need arises. When the sanitary cover is soiled, it can be washed and reused several times.

When the elastic Velcro band is placed over the original cover, place the edge of the band with Velcro towards the inner area (middle of the headphone) and place the paper or fiber cover on the Velcro band, push it slightly and so that it won't be out of place.

Moreover, in case of headphone that are for public use, sanitary cover should be limited in use. After it was used once, place them in the collection box to wash it in sanitary way so that it can be recycled.

### INDUSTRIAL APPLICABILITY

This can be used in the business as sanitary cover that prevents headphone speaker from being contaminated which are caused by natural secretions from human skin such as sebum and sweat.

1. Sanitary headphone speaker cover that can be placed over the original headphone speaker cover with the sanitary cover (sanitary canopy, over canopy, outer cover) that can match the shape and size of the headphone, good absorption of sebum and sweat, detachable from speaker cover, does not tear when it is wet, and processed to have good air permeability where paper towel cover (005) is added to it.

2. Sanitary headphone speaker cover made from processed fiber of paper, paper towel or synthetic fiber (007) that has elastic band (003) and small Velcro (006) in several places that is formed in a certain shape according to the speaker cover.

3. Sanitary headphone speaker cover where above mentioned paper cover (007) from clause 1 and 2 has two to four plies and where there is a sebum absorption paper in the middle.
